(19) United States
(12) Patent Application Publication
(10) Pub. No.: US 2026/0323545 A1
(43) Pub. Date: Oct. 15, 2026

(54) CLOCK SYNCHRONIZATION BETWEEN DEVICES OVER SIDELINK IN A WIRELESS COMMUNICATIONS NETWORK

(71) Applicant: Lenovo (Singapore) Pte. Limited, Singapore (SG)

(72) Inventors: Dimitrios Karampatsis, Ruislip (GB); Karthikeyan Ganesan, Nauheim (DE)

(73) Assignee: Lenovo (Singapore) Pte. Limited, Singapore (SG)

(21) Appl. No.: 19/109,362

(22) PCT Filed: Nov. 9, 2022
(86) PCT No.: PCT/EP2022/081261

§ 371 Date: Mar. 6, 2025

(30) Foreign Application Priority Data
Sep. 9, 2022 (GR) 20220100735

(51) Int. Cl. H04W 56/00; H04W 92/18

(52) U.S. Cl. CPC H04W 56/001; H04W 92/18

(57) ABSTRACT

There is provided a network node in a wireless communications network, comprising: a receiver arranged to receive first reference clock information for clock synchronization. The network node further comprises a processor arranged to determine whether to transmit reference clock information over a sidelink connection to a second network node of the wireless communication network, the processor being further arranged to determine second reference clock information for the second network node. The network node further comprising a transmitter arranged to transmit the second reference clock information to the second network node over the sidelink connection.

### FIELD

The subject matter disclosed herein relates generally to the field of implementing clock synchronization between devices over sidelink in a wireless communications network. This document defines a network node in a wireless communication network and a method in a network node, the network node in a wireless communication network.

### BACKGROUND

Since Release 17 (3GPP TS 23.501), the 3^{rd} Generation Partnership Project (3GPP) has had a defined procedure for supporting Time Sensitive Networks (TSN) within the 3GPP system. The 3GPP system supports TSN in the following ways: the 5GS is integrated with the external network as a TSN bridge; TSN translators (Network Side TSN Translator (NW-TT) and Device Side TSN Translator (DS-TT)) achieve time synchronization between external TSN clocks and the internal 5GS clock; and an Application Function (AF) provides Quality of Service (QOS)/synchronization requirements to the 3GPP system that the Session Management Function (SMF) in the 5G core converts into Time Sensitive Communications (TSC) assistance Information the TSC assistance Information describing traffic characteristics (e.g. burst arrival time) that is used by the Radio Access Network (RAN) to schedule the TSN traffic.

TSN Translators (DS-TT in the User Equipment (UE); NW-TT in the User Plane Function (UPF)) achieve clock synchronization using their internal clock. The internal clock is the 5GS clock (that is used by all entities within the 3GPP network). When clock synchronization is carried out at the DS-TT the UE receives the 5GS clock information to be used as internal clock (also known as working clock) from a gNodeB (gNB) via Radio Resource Control (RRC) signaling. Technical Specification 3GPP TS 38.xyz describes the information the gNB provides to the UE within a DL Information Transfer message.

### SUMMARY

Sidelink offers an ability for UE to communicate without relaying their data via a network. If sidelink is to be used to support TSN through the exchange of TSN information, the DS-TT devices need information on how to support clock synchronization.

Disclosed herein are procedures for clock synchronization between devices over sidelink in a wireless communication network. In particular how clock synchronization is achieved over sidelink; how UEs are configured to exchange clock information over sidelink; and methods to exchange clock information provided by the RAN or use of an internal clock. Said procedures may be implemented by a network node in a wireless communication network, and methods in a network node, the network node in a wireless communication network.

There is provided a network node in a wireless communications network, comprising: a receiver arranged to receive first reference clock information for clock synchronization; a processor arranged to determine whether to transmit reference clock information over a sidelink connection to a second network node of the wireless communication network, the processor being further arranged to determine second reference clock information for the second network node; and a transmitter arranged to transmit the second reference clock information to the second network node over the sidelink connection.

There is further provided a network node in a wireless communication network, comprising: a receiver arranged to receive over a sidelink connection the second reference clock information; and a processor arranged to adjust a working clock of the network node using the second reference clock information.

There is further provided a method in a network node, the network node in a wireless communication network, the method comprising: receiving first reference clock information for clock synchronization; determining to transmit reference clock information over a sidelink connection to a second network node of the wireless communication network; determining second reference clock information for the second network node; and transmitting the second reference clock information to the second network node over the sidelink connection.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Where the term ‘TSN clock’ is used this is intended to refer to the reference clock used by the TSN for synchronizing transmission of packets.

Where the term ‘5GS clock’ is used this is intended to refer to the reference clock used in the 5GS network for synchronizing transmission of packets.

Where the term ‘Internal clock’ is used, this is intended to refer to the clock used as a reference in a UE for synchronizing the TSN clock.

Where the term ‘Working clock’ is used, this is intended to refer to the internal clock in a UE adjusted according to reference information received from a gNB.

Methods and apparatus for clock synchronization between devices over sidelink in a wireless communications network will now be described, by way of example only, with reference to the accompanying drawings, in which:

FIG. 1 illustrates an embodiment of a wireless communication network;

FIG. 2 illustrates an embodiment of a user equipment apparatus;

FIG. 3 illustrates an embodiment of a network node;

FIG. 4 illustrates support of TSN within 3GPP;

FIG. 5 illustrates clock synchronization implementation at DS-TT in 3GPP;

FIG. 6 illustrates reference time information provided by a gNB in 3GPP;

FIG. 7 illustrates an embodiment of TSN communication over sidelink;

FIG. 8 illustrates an embodiment of a method in a network node, the network node in a wireless communication network;

FIG. 9 illustrates an embodiment of clock synchronization over sidelink between UEs;

FIG. 10 illustrates an embodiment of discovery and negotiation of receiving clock reference information between UEs; and

FIG. 11 illustrates an embodiment of supporting exchange of clock information over sidelink between UEs.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

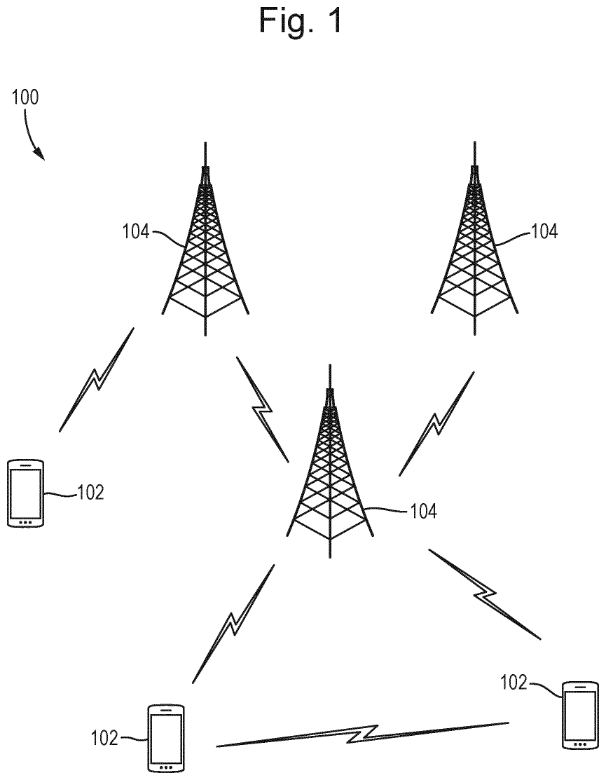

FIG. 1 depicts an embodiment of a wireless communication system 100 for clock synchronization between devices over sidelink in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”'), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA 2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

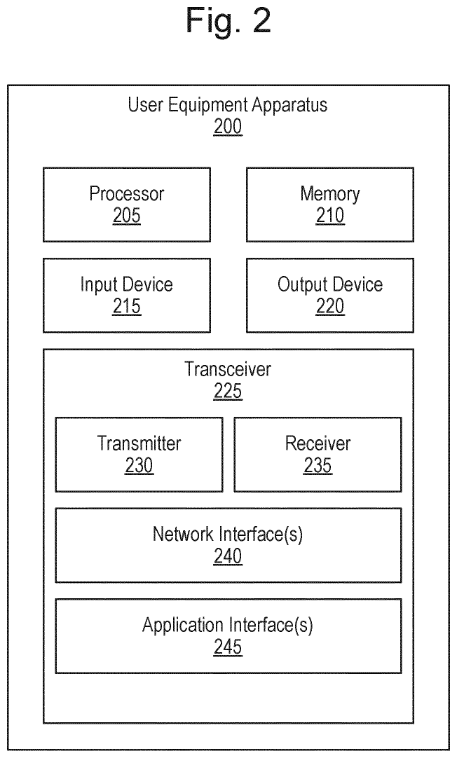

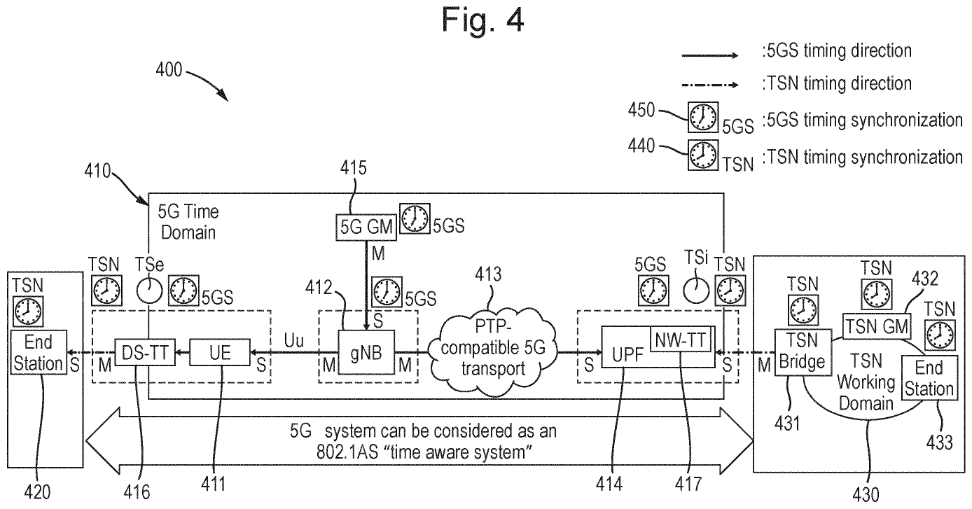

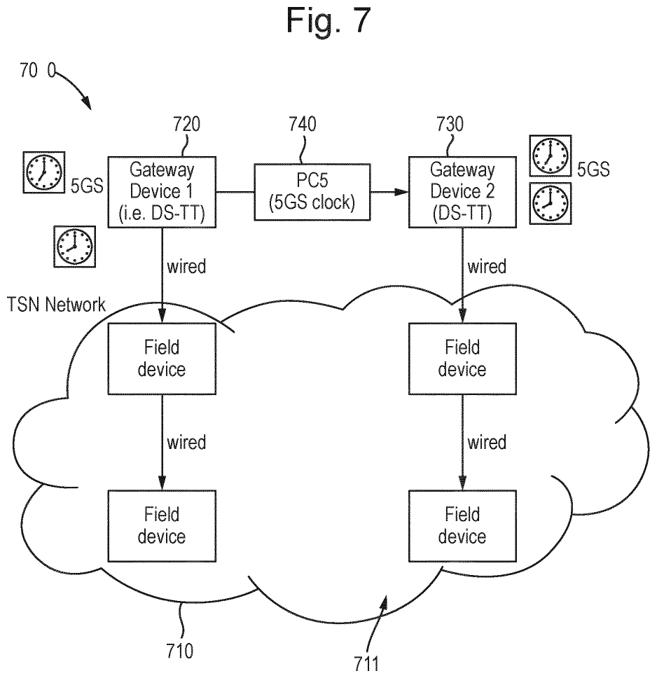

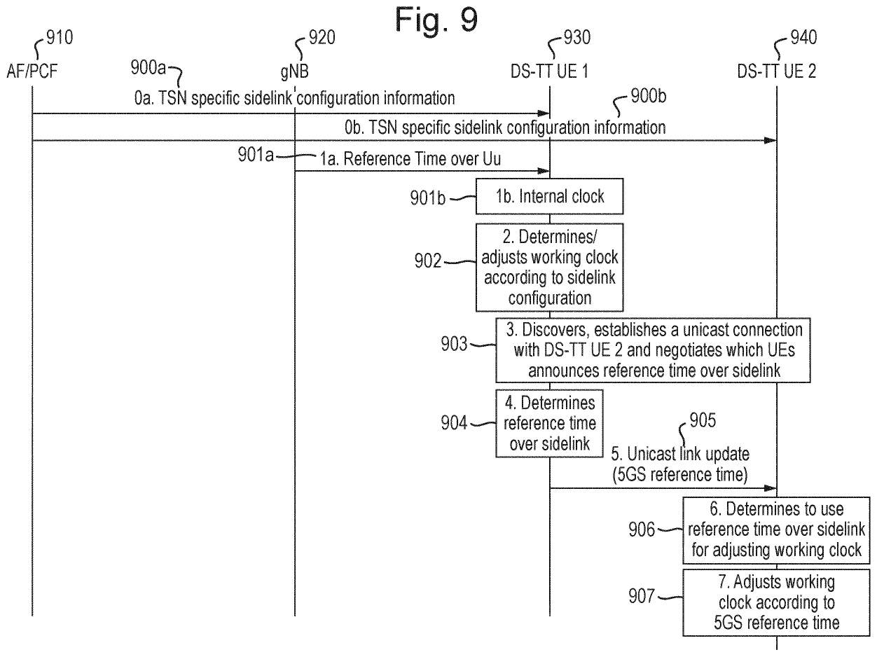

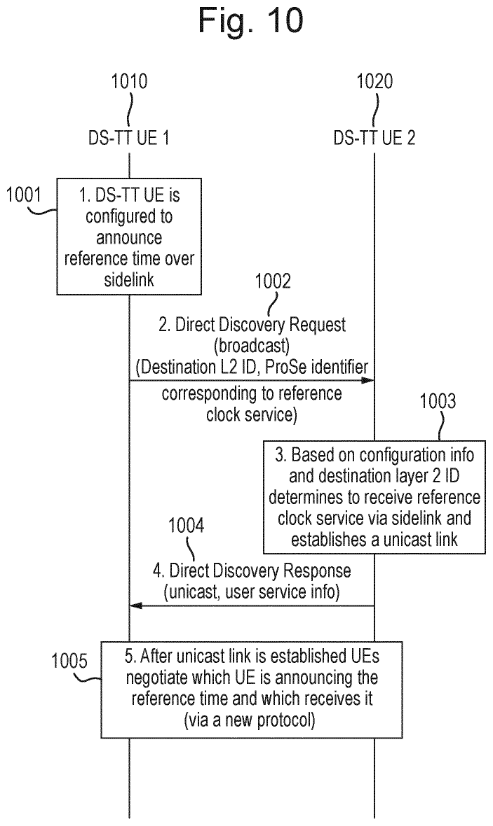

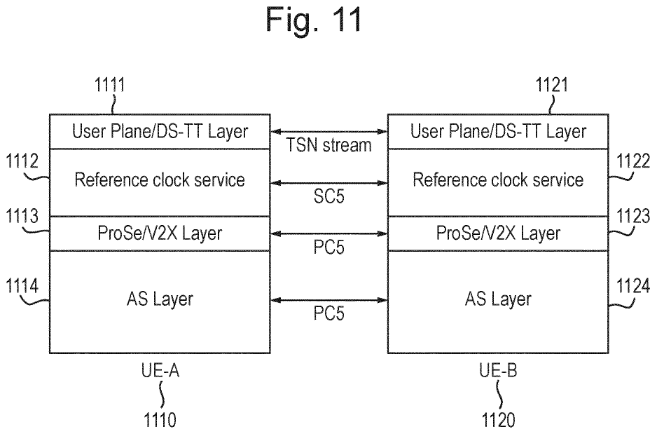

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 is in accordance with the apparatus 102 of FIG. 1; the user equipment 411 of FIG. 4; the devices 720 and 730 for instance of FIG. 7; the user equipment 930 and 940 of FIG. 9; the user equipment 1010 and 1020 of FIG. 10 for instance; and user equipment 1110 and 1120 in FIG. 11, and as such the reference numeral 200 is used hereinafter to indicate a user equipment apparatus in accordance with these apparatuses/user equipments. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. The one ore more transmitters 230 and receivers 235 may provide sidelink connectivity to other network nodes/UEs. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

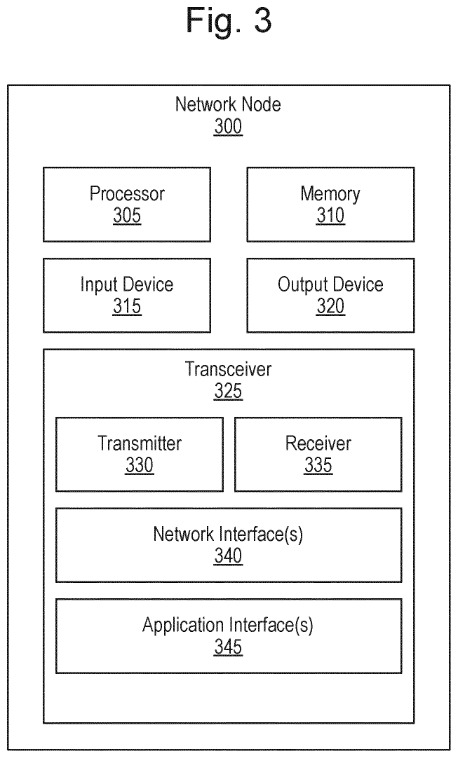

FIG. 3 depicts further details of the network node 300 that may be used for implementing the methods described herein. The network node 300 may be one implementation of an entity in the wireless communications network, e.g. in one or more of the wireless communications networks described herein. The network node 300 may be, for example, the UE 200 described above, or a Network Function (NF) or Application Function (AF), or another entity, of one or more of the wireless communications networks of embodiments described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. The one or more transmitters 330 and receivers 335 may enable sidelink connectivity to other network nodes/UEs. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

FIG. 4 illustrates in an embodiment 400 the support of TSN within 3GPP. A 5GS time domain 410 is illustrated and residing therein is a UE 411, a gNB 412, a PTP compatible 5G transport 413, a UPF 414, and a 5G GM 415. The UE 411 is shown interfacing with a DS-TT 416. The UPF 414 is shown interfacing with an NW-TT 417. 5GS timing directions within the 5GS time domain 410 are also illustrated. The embodiment 400 also shows an end station 420 in a TSN domain interfacing via the DS-TT 416 with the UE 411. The TSN timing direction between the DS-TT 416 and the end station 420 is shown. A TSN working domain 430 is also shown having a TSN bridge 431 interfacing with the NW-TT 417. The TSN working domain 430 also has a TSN-GM 432 and an end station 433. The TSN timing direction between the TSN bridge 431 and the NW-TT 417 is also shown. The end station 420, the TSN bridge 431, the TSN GM 432 and the end station 433 all operate at TSN time synchronization 440. The UE 411, gNB 412, PTP compatible 5G transport 413, UPF 414 and 5G GM 415 all operate at 5GS time synchronization 450. The 5G system 400 can be considered as an 802.1AS time aware system. The system 400 supports TSN networks by the 5GS 410 being integrated with external networks via the TSN bridge 431. The system 400 further supports TSN networks by the TSN translators 416 and 417 achieving time synchronization between the external TSN clocks and internal 5GS clock. The system 400 may further support TSN networks by an AF providing QoS/synchronization requirements to the 3GPP system that the SMF in the 5G core converts into TSC assistance information. The TSC assistance information describes traffic characteristics (e.g. burst arrival time) that is used by the RAN to schedule TSN traffic. A general architecture to support TSN networks is further provided in 3GPP Technical Specification 23.501.

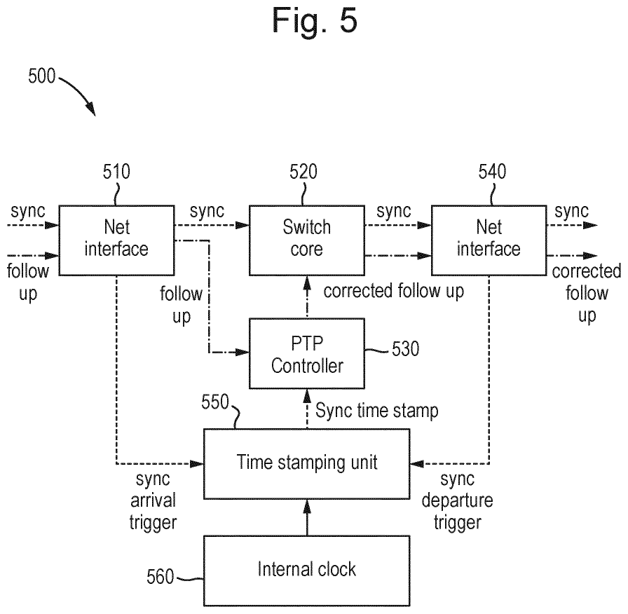

FIG. 5 illustrates an embodiment 500 of clock synchronization implementation at DS-TT in 3GPP. This embodiment illustrates how a device can use the internal clock to synchronize an external TSN clock. The embodiment 500 shows a first net interface 510, a switch core 520, a PTP controller 530, a second net interface 540, a time stamping unit 550 and an internal clock 560. The first net interface 510 is illustrated as receiving sync and follow up, and providing sync to switch core 520 and follow up to PTP controller 530. A sync arrive trigger is also provided from first net interface 510 to time stamping unit 550. The internal clock 560 interfaces with the time stamping unit 550 which provides a sync time stamp to the PTP controller 530. The PTP controller 530 provides a corrected follow up to the switch core 520, with the switch core 520 providing sync and corrected follow up to the second net interface 540. The sync and corrected follow up is output from the second net interface 540, and a sync departure trigger is illustrated as passing to the time stamping unit 550.

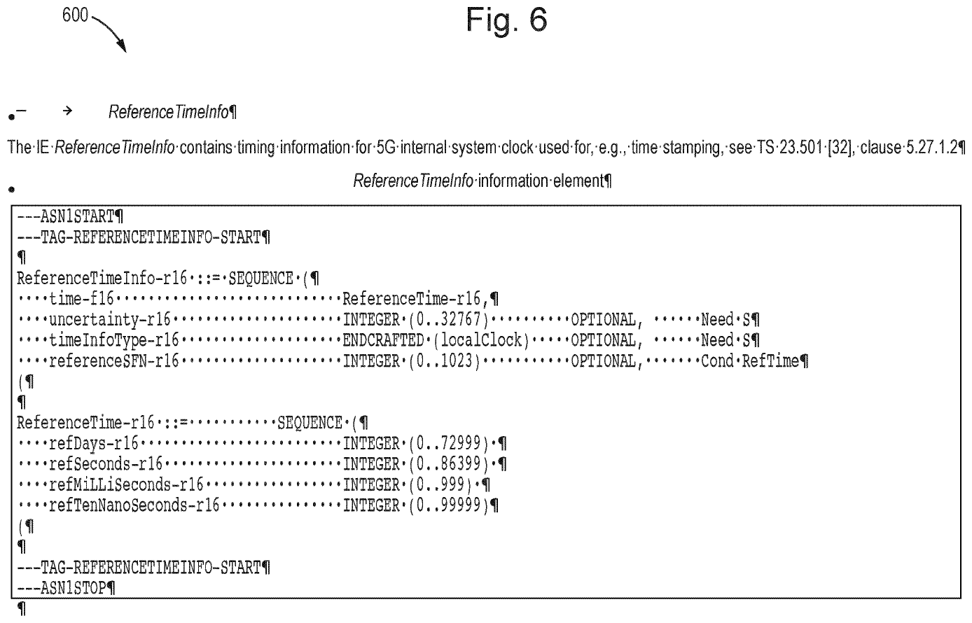

FIG. 6 illustrates reference time information provided by a gNB to a UE in 3GPP. The illustration 600 shows the time information provided in a DLInformation Transfer message as specified in 3GPP Technical Specification 38.xyz.

FIG. 7 illustrates an embodiment 700 of TSN communication over sidelink. The embodiment 700 shows a TSN network 710 comprising a plurality of field devices 711. First and second gateway devices 720, 730, are shown interfacing with the TSN network 710 (for instance DS-TT). The first and second gateway devices 720, 730, are shown communicating over sidelink over PC5 740 and sharing clock information.

Described herein is a network node in a wireless communication network, comprising a receiver arranged to receive first reference clock information for clock synchronization. The network node further comprises a processor arranged to determine whether to transmit reference clock information over a sidelink connection to a second network node of the wireless communication network, the processor being further arranged to determine second reference clock information for the second network node. The network node further comprises a transmitter arranged to transmit the second reference clock information to the second network node over the sidelink connection.

In some embodiments the receiver is arranged to receive the first reference clock information from a RAN node of the wireless communications network. The RAN node may be a gNodeB for instance.

In some embodiments the receiver is arranged to receive the first reference clock information from an internal clock of the network node.

In some embodiments the receiver is further arranged to receive configuration information and the processor is further arranged to determine whether to transmit reference clock information over the sidelink connection based on the configuration information.

In some embodiments the receiver is arranged to receive the configuration information from a Policy Control Function, an Application Function, or a pre-configuration of the network node.

In some embodiments the configuration information associates a Service Identifier (for instance a ProSe Identifier) corresponding to a reference clock service function of the network node, to a sidelink cast type, a destination layer 2 identifier and/or a sidelink quality of service requirement.

In some embodiments the sidelink cast type comprises any sidelink cast type from the list of sidelink cast types consisting of: broadcast sidelink cast type; groupcast sidelink cast type; and unicast sidelink cast type.

In some embodiments the transmitter is further arranged to transmit the second reference clock information to the second network node using the sidelink cast type, destination layer 2 identifier and/or sidelink quality of service requirement.

In some embodiments the processor is further arranged to process a quality of service requirement, a latency and a radio condition of the sidelink connection to determine the second reference clock information.

In some embodiments the processor is further arranged to control the transmitter to transmit a resource configuration request to a RAN node requesting the second reference clock information.

In some embodiments the resource configuration request includes the sidelink quality of service requirement for communicating to the second network node.

In some embodiments the transmitter is arranged to transmit the second reference clock information to the second network node over the sidelink connection over a user plane or over control plane signaling.

In some embodiments the processor is further arranged to control the receiver and transmitter to discover the second network node; and then to establish a sidelink connection with the second network node.

In some embodiments either or both of the network node and second network node is a user equipment.

Also described herein is a a network node in a wireless communication network, comprising: a receiver arranged to receive over a sidelink connection the second reference clock information; and a processor arranged to adjust a working clock of the network node using the second reference clock information.

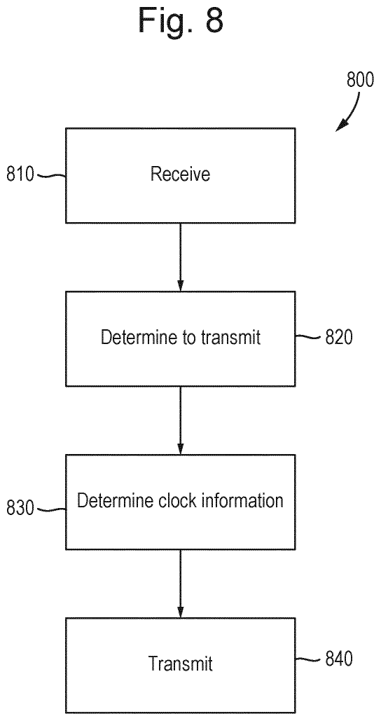

FIG. 8 illustrates an embodiment of a method 800 in a network node, the network node in a wireless communication network. In a first step 810 the network node receives first reference clock information for clock synchronization. In a second step 820 the network node determines to transmit reference clock information over a sidelink connection to a second network node of the wireless communication network. In a third step the network node determines second reference clock information for the second network node. In a fourth step, the network node transmits the second reference clock information to the second network node over the sidelink connection.

In some embodiments, the receiving first reference clock information for clock synchronization comprises receiving the first reference clock information from a RAN node of the wireless communication network.

In some embodiments, the receiving first reference clock information for clock synchronization comprises receiving the first reference clock information from an internal clock of the network node.

In some embodiments, the determining to transmit reference clock information over a sidelink connection to the second network node of the wireless communication network, comprises: receiving configuration information; and determining based on the configuration information whether to transmit reference clock information over sidelink to the second network node.

In some embodiments, the configuration information is received from either of a Policy Control Function, an Application Function or a pre-configuration of the network node.

In some embodiments the configuration information associates a Service Identifier (for instance a ProSe Identifier) corresponding to a reference clock service function of the network node, to a sidelink cast type, a destination layer 2 ID, and/or a sidelink quality of service requirement.

In some embodiments the sidelink cast type comprises any sidelink cast type from the list of sidelink cast types consisting of: broadcast sidelink cast type; groupcast sidelink cast type; and unicast sidelink cast type.

In some embodiments transmitting the second reference clock information to the second network node over the sidelink connection, comprises transmitting the second reference clock information using the sidelink cast type, destination layer 2 ID and/or quality of service requirement.

In some embodiments the determining second reference clock information for the second network node comprises considering a quality of service requirement of the sidelink connection, a latency over the sidelink connection, and a radio condition.

In some embodiments the determining second reference clock information for the second network node comprises transmitting a resource configuration request to a RAN node requesting the second reference clock information.

In some embodiments the resource configuration request includes the sidelink quality of service requirement for communicating to the second network node.

In some embodiments the transmitting the second reference clock information to the second network node over the sidelink connection, comprises transmitting the second reference clock information over a user plane or over control plane signaling.

In some embodiments the determining to transmit clock reference information over a sidelink connection to a second network node of the wireless communication network comprises: discovering the second network node; and establishing a sidelink connection with the second network node.

In some embodiments either or both of the network node and second network node is a user equipment.

There are a number of options to achieve clock synchronization over sidelink which include the UE supporting DS-TT being in RAN coverage and using the 5GS clock information provided by the RAN; and the UE supporting DS-TT not being within RAN coverage and using its own internal clock for synchronizing the call to another UE. With regard to the reference architecture shown in FIG. 7, the second DS-TT UE 730 that has a sidelink connection with a first DS-TT UE 720 needs to receive time reference information in order to use as working clock for TSN clock synchronisation. Depending on the option used the first DS-TT UE 720 needs to provide reference information to a second DS-TT UE 730 over sidelink to allow the second DS-TT UE 730 to determine the working clock. This procedure will now be described with respect to FIG. 9, which illustrates an embodiment of clock synchronization over sidelink between UEs.

The embodiment in FIG. 9 comprises an AF/PCT 910, a gNB 920, a DS-TT UE1 930 and a DS-TT UE2 940. In initial steps 900a and 900b, the DS-TT UE1 930 and UE2 940 receive configuration information for supporting TSN systems from the PCF/AF 910. In subsequent steps 901a and 901b, the DS-TT UE1 930 receives reference time information from gNB 920 (when UE 930 is in coverage) for use as a working clock to synchronise the TSN clock; and/or the DS-TT UE1 930 uses its internal clock for use as a working clock to synchronise the TSN clock. The DS-TT UE1 930 determines to use its internal clock based on configuration information (e.g. when the UE 930 is out of coverage of a gNB 920). In a subsequent step 902, the DS-TT UE1 930 determines based on configuration information whether to use the 5GS reference time provided by gNB 920 or its own internal clock. If the UE 930 uses the 5GS reference time provided by the gNB 920 the UE 930 adjusts its working clock according to the reference time information. In a subsequent step 903, the DS-TT UE1 930 discovers and establishes a sidelink connection (i.e. a unicast connection) with a second DS-TT UE2 940. Both UEs 930, 940, may negotiate via a new protocol which UE will be the announcing UE for sending reference time over sidelink. The discovery may be carried out using TSN specific sidelink configuration information. In a subsequent step 904, based on the TSN specific sidelink configuration information the DS-TT UE1 930 determines that timing reference information needs to be provided over sidelink to the second DS-TT UE2 940. The DS-TT UE1 930 determines time reference information taking into account the latency between UE1 930 and UE2 940 over sidelink. Configuration information may include default QoS requirements for sending the reference information over sidelink. The UE1 930 can determine the latency taking into account the QOS requirements and radio signal strength. In a subsequent step 905, the UE1 930 provides reference time to UE2 940 over unicast connection to a corresponding QOS flow according to the QoS requirements. In a subsequent step 906, based on the TSN specific sidelink configuration DS-TT UE2 940 determines to use reference time over sidelink for adjusting working clock. In a subsequent step 907, DS-TT UE2 940 adjusts the working clock taking into account information provided in step 906.

In alternative embodiments when the UE1 930 determines that clock configuration is to be sent over to a second UE 940, if UE1 930 is in coverage the UE1 930 may send a resource configuration request to the gNB 920 requesting reference time information to provide to a second UE 940 over sidelink. UE1 930 includes to the gNB 920 the QOS requirements for sending the clock over sidelink to a second UE 940. The gNB 920 calculates the reference time information taking into account the number of hops that the clock needs to be distributed over sidelink.

FIG. 10 illustrates an embodiment of discovery and negotiation of receiving clock reference information between UEs. The embodiment illustrates a DS-TT UE1 1010 and a DS-TT UE2 1020. In a first step 1001, based on configuration information and/or trigger from the reference time application the UE1 1001 determines that it needs to announce it supports a reference time service over sidelink. In a subsequent step 1002, UE1 1001 sends a Direct Discovery request to a Destination Layer-2 ID associated to the reference time service. Within the request a ProSe Identifier corresponding to the reference time service may be included. In a subsequent step 1003, UE2 1020 receives the announce message from UE1 1010. Based on configuration information or trigger from the reference time service UE2 1020 determines that it is interested to receive reference time service from UE1 1010 and determines to establish a unicast link. In a subsequent step 1004, UE2 1020 responds with a direct discovery response triggering a unicast link establishment. In a subsequent step 1005, after the unicast link is established the UEs 1010, 1020 negotiate via a new protocol which UE will be announcing the reference time. The protocol may be exchange via PC5-S (control plane) or via user plane signaling over the unicast link.

FIG. 11 illustrates an embodiment of supporting exchange of clock information over sidelink between UEs. This is achieved through provision of an additional layer for exchanging clock information. The figure illustrates a UE-A 1110 and a UE-B 1120. Each UE 1110, 1120 is shown as having multiple layers in the sidelink respectively, comprising a user plane/DS-TT layer 1111 and 1121; a reference clock service 1112 and 1122; a ProSe/V2X layer 1113 and 1123; and an AS layer 1114 and 1124. The layers 1111 and 1121 interface using TSN stream. The layers 1112 and 1122 interface using SC5. The layers 1113 and 1123 interface using PC5. The layers 1114 and 1124 interface using PC5.

The reference clock service 1112 and 1122 may be a function in the UE 1110 and 1120 or a function of the DS-TT within the UE 1110 and 1120. The reference clock service 1112 and 1122 may also be supported by the application. The two UEs 1110 and 1120 exchange clock information via a new interface over sidelink (SC5). The reference information may be transported over a new protocol over SC5 via userplane over a unicast connection or may be exchanged via control plane messages over PC5-S. When transported over PC5-S the clock information is exchanged over PC5-S containers.

The reference clock service layer 1112 and 1122 may support one or more of the following functions: a discovery service-discovering other UEs that support clock synchronization; group member information-information on which group of UEs participate in clock synchronization; reference clock function-information on whether to use clock information provided by gNB, clock information provided by sidelink or use of an internal clock (where the internal clock is using clock information from different source, e.g., GNSS).

In order to support exchange of clock information over PC5, the reference clock service 1112 and 1122 in the UE 1110 and 1120 is configured with a specific ProSe Identifier or ProSe Application ID. In addition, each reference clock service function 1112 and 1122 described above may be configured with a different ProSe Identifier or Prose Application ID. The UE 1110 and 1120 is configured to convey reference clock information over a specific ProSe Application ID by receiving ProSe configuration information from the PCF and/or AF (or pre-configured in the UE). The ProSe configuration information includes: a mapping of ProSe identifier/ProSe Application ID (corresponding to Reference Clock Service) to a Destination Layer-2 ID for unicast/groupcast or broadcast; identifiers associated to a reference clock service to be used for direct discovery over PC5; a mapping of ProSe identifier/ProSe Application ID (corresponding to Reference Clock Service) to PC5 QoS parameters; group member discovery parameters (in case all UEs supporting sidelink exchange clock information over groupcast).

For each discovery group that the UE 1110 or 1120 belongs to, include the following parameters that enable the UE 1110 or 1120 to perform Group Member Discovery: Application Layer Group ID-identifies an application layer group or a discovery group that the UE belongs; layer-2 Group ID-layer-2 ID for Application Layer Group ID; User Info ID-this corresponds to the Announcer Info parameter when the UE 1110 or 1120 is acting as an announcing UE or the Discoverer Info in Solicitation messages and the Discoveree Info in Response messages, when the UE 1110 or 1120 is acting as a discoverer or discoveree UE respectively.

The UE 1110 or 1120 may also receive configuration information as part of ProSe configuration, including the following: 5GS clock reference information—information whether the UE 1110 or 1120 should use its internal clock, reference clock provided by gNB or reference clock provided via sidelink.

The 5GS clock reference information can also be provided outside of ProSe configuration information. The UE 1110 or 1120 is pre-configured or uses implementation means to determine when to distribute clock information. Or the UE 1110 or 1120 receives configuration network from the network configuring the reference clock service function in the reference clock service layer 1112 or 1122 on whether the UE 1110 or 1120 use its internal clock, reference clock provided by gNB or reference clock provided via sidelink. In addition the reference clock function may receive configuration information of the QoS requirements to transmit the clock reference information over sidelink.

One approach is described as follows. When UE 1110 is in coverage and receives clock information from the RAN, the UE 1110 forwards the clock information (taking into account the latency over the sidelink path) to the second UE 1120 over sidelink according to ProSe configuration information (i.e. send clock info over a specific ProSe Application ID). When the UE 1110 is out of coverage and the UE 1110 has reference clock configuration the UE 1110 transmits its internal clock (taking into account the latency over sidelink path) to a second UE 1120 over sidelink according to ProSe configuration information (i.e. send clock info over a specific ProSe Application ID).

The disclosure herein relates to supporting TSN using sidelink where some of the devices exchange TSN information using sidelink. If sidelink is used the DS-TT devices need also to have information on how to support clock synchronization. This disclosure addresses the following: how clock synchronization is achieved over sidelink; how UEs are configured to exchange clock information over sidelink; methods to exchange clock information provided by RAN or use of an internal clock.

The solution described herein proposes the UEs supporting DS-TT function to support a new function, a reference clock service function, which has the functionality to exchange clock sync information to a second UE over sidelink. The solution also proposes how such UEs are configured to exchange information provided from the reference clock service layer in the UE to identifiers and cast type over sidelink and support discovery of UEs over sidelink and establishing a connection over sidelink to exchange clock sync information. Specifically, in this scenario a function of the UE (i.e. a reference clock service function) is configured to use specific parameters over sidelink.

A method for supporting clock synchronization over sidelink is disclosed, the method comprising receiving at a first device first reference clock information for clock synchronization; determining to transmit clock reference information to a second device over sidelink; determining second reference clock information for the second device; transmitting reference clock information to a second device over a sidelink connection.

Preferably the first reference clock information is provided by a RAN node.

Preferably the first reference clock information is provided by a reference clock service function within the first device.

Preferably the first device determines to transmit clock synchronization to a second device based on configuration information provided by the network [PCF/AF]

Preferably the configuration information associates a ProSe identifier corresponding to reference clock service function to a sidelink cast type (Broadcast/groupcast/unicast)

Preferably the configuration information associates a ProSe identifier corresponding to reference clock service function to a destination layer 2 ID over sidelink.

Preferably the configuration information associates a ProSe identifier corresponding to a reference clock service function to QoS requirements over sidelink

Preferably the first device determines reference clock information for the second device taking into account the QoS requirement of the sidelink connection, latency over the sidelink path and radio conditions.

Preferably the first device determines reference clock information for the second device by request sidelink resources from a RAN node when the first device is in coverage.

Preferably the request to the RAN node includes a request for clock reference info and the QoS requirements over sidelink.

Preferably the clock reference information is sent over sidelink over a user plane.

Preferably the clock reference information is sent over sidelink over control plane signaling (PC5-S).

Preferably the device transmit clock reference information to a second device using a destination layer 2 ID, cast type and QoS according to configuration information received from the network.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations used herein are listed below:
UE User Equipment
TSN Time Sensitive Networks
DS-TT Device Side TSN Translator
NW-TT Network Side TSN Translator

1. A network node for wireless communication, comprising:
at least one memory; and
at least one processor coupled with the at least one memory and arranged to cause the network node to:
receive first reference clock information for clock synchronization;
determine whether to transmit reference clock information over a sidelink connection to a second network node;
determine second reference clock information for the second network node; and
transmit the second reference clock information to the second network node over the sidelink connection.

2. The network node of claim 1, wherein to receive the first reference clock information, the at least one processor is further arranged to cause the network node to receive the first reference clock information from a radio access network (RAN) node of a wireless communications network.

3. The network node of claim 1, wherein to receive the first reference clock information, the at least one processor is further arranged to cause the network node to receive the first reference clock information from an internal clock of the network node.

4. The network node of claim 1, wherein the at least one processor is further arranged to cause the network node to:
receive configuration information; and
determine whether to transmit reference clock information over the sidelink connection based at least in part on the configuration information.

5. The network node of claim 4, wherein to receive the configuration information, the at least one processor is further arranged to cause the network node to receive the configuration information from a policy control function, an application function, or a pre-configuration of the network node.

6. The network node of claim 4, wherein the configuration information associates a service identifier that corresponds to a reference clock service function of the network node, to at least one of a sidelink cast type, a destination layer 2 identifier, or a sidelink quality of service requirement.

7. The network node of claim 6, wherein the sidelink cast type comprises at least one of:
a broadcast sidelink cast type;
a groupcast sidelink cast type; or
a unicast sidelink cast type.

8. The network node of claim 6, wherein the at least one processor is further arranged to cause the network node to transmit the second reference clock information to the second network node using at least one of the sidelink cast type, the destination layer 2 identifier, or the sidelink quality of service requirement.

9. The network node of claim 1, wherein to determine the second reference clock information, the at least one processor is further arranged to cause the network node to process a quality of service requirement, a latency, and a radio condition of the sidelink connection.

10. The network node of claim 9, wherein the at least one processor is further arranged to cause the network node to transmit a resource configuration request to a radio access network (RAN) that requests the second reference clock information.

11. The network node of claim 10, wherein the resource configuration request includes the quality of service requirement for communicating to the second network node.

12. The network node of claim 1, wherein to transmit the second reference clock information, the at least one processor is further arranged to cause the network node to transmit the second reference clock information to the second network node over the sidelink connection over a user plane or over control plane signaling.

13. The network node of claim 1, wherein the at least one processor is further arranged to cause the network node to:
discover the second network node; and
establish, after discovering the second network node, the sidelink connection with the second network node.

14. The network node of preceding claim 1, wherein at least one of the network node and the second network node is a user equipment (UE).

15. A network node for wireless communication, comprising:
at least one memory; and
at least one processor coupled with the at least one memory and arranged to cause the network node to:
receive reference clock information over a sidelink connection and
adjust, based at least in part on the reference clock information, a working clock of the network node.

16. A method performed by a network node, the method comprising:
receiving first reference clock information for clock synchronization;
determining to transmit reference clock information over a sidelink connection to a second network node of a wireless communication network;
determining second reference clock information for the second network node; and
transmitting the second reference clock information to the second network node over the sidelink connection.

17. (canceled)

18. (canceled)

19. The method of claim 16, wherein the determining to transmit reference clock information over a sidelink connection comprises:
receiving configuration information; and
determining, based at least in part on the configuration information, whether to transmit reference clock information over sidelink to the second network node.

20-29. (canceled)

30. The network node of claim 15, wherein the at least one processor is further arranged to cause the network node to receive the reference clock information using at least one of a sidelink cast type, a destination layer 2 identifier, or a sidelink quality of service requirement.

31. The network node of claim 15, wherein to receive the reference clock information, the at least one processor is further arranged to cause the network node to receive the reference clock information over the sidelink connection over a user plane or over control plane signaling.

32. A method performed by a network node, the method comprising:
receiving reference clock information over a sidelink connection; and
adjusting, based at least in part on the reference clock information, a working clock of the network node.
